(19) United States
(12) Patent Application Publication
(10) Pub. No.: US 2025/0217750 A1
(43) Pub. Date: Jul. 3, 2025

(54) SYSTEMS AND METHODS FOR GATHERING AGENT PERFORMANCE METRICS AND TRANSLATING METRICS TO NORMALIZED GOAL PERCENTAGES TO EVALUATE AGENT PERFORMANCE

(71) Applicant: Genesys Cloud Services, Inc., Menlo Park, CA (US)

(72) Inventors: Rakesh Tailor, Toronto (CA); Corey Weber, Toronto (CA); Jacou Sarrazin, Toronto (CA); Alex Lee, Toronto (CA)

(21) Appl. No.: 18/399,307

(22) Filed: Dec. 28, 2023

(51) Int. Cl. G06Q 10/0639; H04M 3/22

(52) U.S. Cl. CPC G06Q 10/06393; H04M 3/2227

(57) ABSTRACT

A method of evaluating agent performance according to an embodiment includes obtaining metric data for one or more agents including a plurality of raw performance indicators each corresponding to a particular agent performance metric of a plurality of agent performance metrics and converting, based on the metric data, each of the plurality of raw performance indicators into a points score for the particular agent performance metric to provide a plurality of points scores for the plurality of agent performance metrics.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. In some cases, it may be difficult to accurately evaluate contact center agent performance relative to the agent's own performance over time and relative to other agents or peers, especially when considering a variety of complicating factors.

### SUMMARY

One embodiment is directed to a unique system, components, and methods for evaluating agent or employee performance. Other embodiments are directed to apparatuses, systems, devices, hardware, methods, and combinations thereof for evaluating agent or employee performance.

According to an embodiment, a system for evaluating agent performance may include at least one processor and at least one memory comprising a plurality of instructions stored therein that, in response to execution by the at least one processor, causes the system to obtain metric data for one or more agents including a plurality of raw performance indicators each corresponding to a particular agent performance metric of a plurality of agent performance metrics, to convert, based on the metric data, each of the plurality of raw performance indicators into a points score for the particular agent performance metric to provide a plurality of points scores for the plurality of agent performance metrics, to calculate, based on the points score, a goal percentage for each particular agent performance metric to provide a plurality of goal percentages for the plurality of agent performance metrics, and to compare, based on the plurality of goal percentages, agent performance over the plurality of agent performance metrics, and to convert each of the plurality of raw performance indicators into a points score comprises to normalize the points score for the particular agent performance metric across a plurality of variables to evaluate agent performance according to a common standard.

In some embodiments, to normalize the points score for the particular agent performance metric may include to establish a plurality of zones in progression toward a target for the conversion of at least one raw performance indicator corresponding to the particular agent performance metric into the points score.

In some embodiments, to normalize the points score for the particular agent performance metric may include to determine the points score based on the particular zone of the plurality of zones that the at least one raw performance indicator falls in.

In some embodiments, to determine the points score based on the particular zone may include to determine whether the at least one raw performance indicator falls in a first zone corresponding to a first points score, and the first points score may be zero points.

In some embodiments, to determine the points score based on the particular zone may include to determine whether the at least one raw performance indicator falls in a second zone closer to the target than the first zone, and the second zone may correspond to a second points score that is greater than the first points score.

In some embodiments, to determine the points score based on the particular zone may include to determine whether the at least one raw performance indicator falls in a third zone closer to the target than the second zone, and the third zone may correspond to a third points score that is greater than the second points score.

In some embodiments, to calculate the goal percentage for each particular agent performance metric may include to multiply the points score for the particular agent performance metric by a predetermined number of days to compute an aggregated points score for the particular agent performance metric over a predefined time interval.

In some embodiments, to calculate the goal percentage for each particular agent performance metric may include to divide the aggregated points score by a maximum number of points achievable over the predefined time interval to determine the goal percentage.

In some embodiments, to compare agent performance over the plurality of agent performance metrics may include to, for each agent in an agent profile selected by a user, display the plurality of goal percentages for a plurality of agent performance metrics assigned to the particular agent to facilitate visualized comparison of agent performance across the selected agent profile.

In some embodiments, to compare agent performance over the plurality of agent performance metrics may include to calculate, for each agent in the selected agent profile, an overall goal percentage value corresponding to an average of the plurality of goal percentages for the plurality of performance metrics assigned to the particular agent.

In some embodiments, to display the plurality of goal percentages for the plurality of agent performance metrics may include to display, for each agent in the selected agent profile, the overall goal percentage value to facilitate visualized comparison of overall goal percentage value across the selected agent profile.

According to another embodiment, a method of evaluating agent performance may include obtaining metric data for one or more agents including a plurality of raw performance indicators each corresponding to a particular agent performance metric of a plurality of agent performance metrics, converting, based on the metric data, each of the plurality of raw performance indicators into a points score for the particular agent performance metric to provide a plurality of points scores for the plurality of agent performance metrics, calculating, based on the points score, a goal percentage for each particular agent performance metric to provide a plurality of goal percentages for the plurality of agent performance metrics, and comparing, based on the plurality of goal percentages, agent performance over the plurality of agent performance metrics, and converting each of the plurality of raw performance indicators into a points score comprises normalizing the points score for the particular agent performance metric across a plurality of variables to evaluate agent performance according to a common standard, and comparing agent performance over the plurality of agent performance metrics comprises comparing, for each agent in an agent profile selected by a user, agent performance for the particular agent over a first predefined time interval to agent performance for the particular agent over a second predefined time interval.

In some embodiments, normalizing the points score for the particular agent performance metric may include establishing a plurality of zones in progression toward a target for the conversion of at least one raw performance indicator corresponding to the particular agent performance metric into the points score, and determining the points score based on the particular zone of the plurality of zones that the at least one raw performance indicator falls in.

In some embodiments, determining the points score based on the particular zone may include determining whether the at least one raw performance indicator falls in a first zone that corresponds to a first points score, determining whether the at least one raw performance indicator falls in a second zone closer to the target than the first zone that corresponds to a second points score, and determining whether the at least one raw performance indicator falls in a third zone closer to the target than the second zone that corresponds to a third points score.

In some embodiments, the first points score may be zero points, the second points score may be greater than the first points score, and the third points score may be greater than the second points score.

In some embodiments, calculating the goal percentage for each particular agent performance metric may include multiplying the points score for the particular agent performance metric by a predetermined number of days to compute an aggregated points score for the particular agent performance metric over a predefined time interval, and dividing the aggregated points score by a maximum number of points achievable over the predefined time interval to determine the goal percentage.

In some embodiments, comparing agent performance over the plurality of agent performance metrics may include displaying, for each agent in the selected agent profile, the plurality of goal percentages for a plurality of agent performance metrics assigned to the particular agent to facilitate visualized comparison of agent performance across the selected agent profile, calculating, for each agent in the selected agent profile, an overall goal percentage value corresponding to an average of the plurality of goal percentages for the plurality of performance metrics assigned to the particular agent, and displaying, for each agent in the selected agent profile, the overall goal percentage value to facilitate visualized comparison of overall goal percentage value across the selected agent profile.

In some embodiments, comparing agent performance over the first predefined time interval to agent performance over the second predefined time interval comprises displaying, for a particular agent in the selected agent profile over each of the first and second predefined time intervals, the goal percentage for the particular agent performance metric, the raw performance indicator corresponding to the particular agent performance metric, a number of days over which metric data including the raw performance indicator has been obtained, and the points score for the particular agent performance metric.

According to yet another embodiment, one or more non-transitory machine readable storage media may include a plurality of instructions stored thereon that, in response to execution by a processor, causes the processor to obtain metric data for one or more agents including a plurality of raw performance indicators each corresponding to a particular agent performance metric of a plurality of agent performance metrics, to convert, based on the metric data, each of the plurality of raw performance indicators into a points score for the particular agent performance metric to provide a plurality of points scores for the plurality of agent performance metrics, to calculate, based on the points score, a goal percentage for each particular agent performance metric to provide a plurality of goal percentages for the plurality of agent performance metrics, and to compare, based on the plurality of goal percentages, agent performance over the plurality of agent performance metrics.

In some embodiments, to convert each of the plurality of raw performance indicators into a points score may include to normalize the points score for the particular agent performance metric across a plurality of variables to evaluate agent performance according to a common standard.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a computing device;

FIG. 2 is a simplified block diagram of at least one embodiment of a contact center system and/or communications infrastructure;

FIG. 3 is at least one embodiment of a visualized representation or display that may be generated by a system included in the computing device of FIG. 1 or the contact center system of FIG. 2;

FIG. 4 is at least one embodiment of another visualized representation or display that may be generated by the system of FIG. 3;

FIG. 5 is at least one embodiment of yet another visualized representation or display that may be generated by the system of FIG. 3;

FIG. 6 is at least one embodiment of yet another visualized representation or display still that may be generated by the system of FIG. 3;

FIG. 7 is a simplified flow diagram of at least one embodiment of a method of evaluating agent performance;

FIG. 8 is a simplified flow diagram of at least one embodiment of a method of performing one of the blocks of the method of FIG. 7;

FIG. 9 is a simplified flow diagram of at least one embodiment of a method of performing another one of the blocks of the method of FIG. 7;

FIG. 10 is a simplified flow diagram of at least one embodiment of a method of performing yet another one of the blocks of the method of FIG. 7;

FIG. 11 is a simplified flow diagram of another embodiment of a method of evaluating agent performance;

FIG. 12 is an embodiment of a visualized representation or display in the form of a scorecard that may be generated by the system of FIG. 3;

FIG. 13 is an embodiment of a visualized representation or display that may be generated in response to selecting or hovering over a metric panel presented in the scorecard of FIG. 12;

FIG. 14 is an embodiment of a visualized representation or display that may be generated in response to selecting or hovering over a gamification zone presented in the display of FIG. 13; and

FIG. 15 is an embodiment of a visualized representation or display providing a graphical illustration of trend data that may be generated using a trend tab presented in the display of FIG. 13 or FIG. 14.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

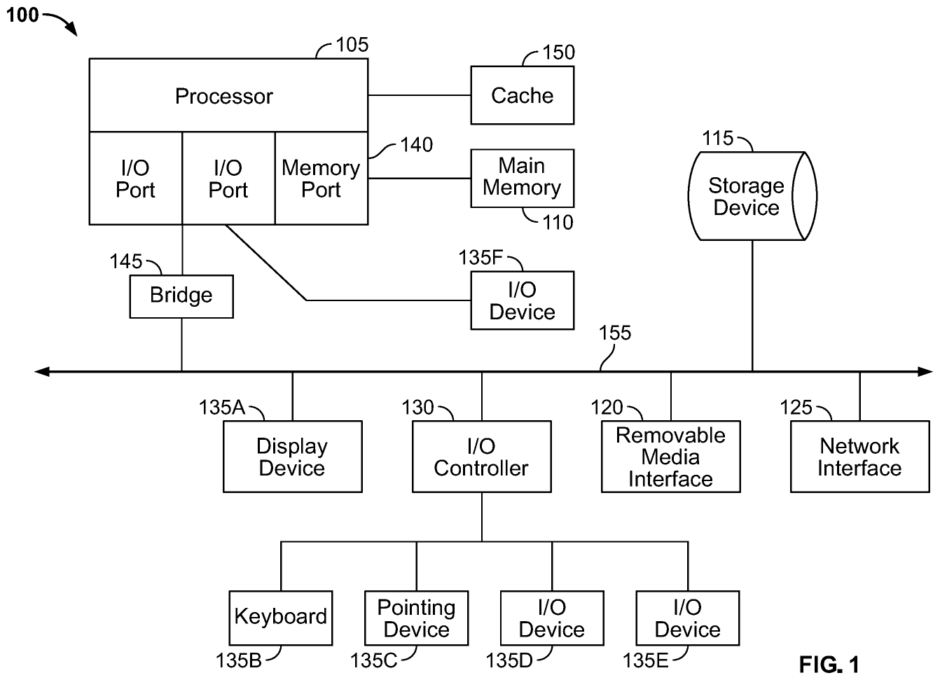

Referring now to FIG. 1, a simplified block diagram of at least one embodiment of a computing device 100 is shown. The illustrative computing device 100 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the servers may be a process or thread running on one or more processors of one or more computing devices 100, which may be executing computer program instructions and interacting with other system modules in order to perform the various functionalities described herein.

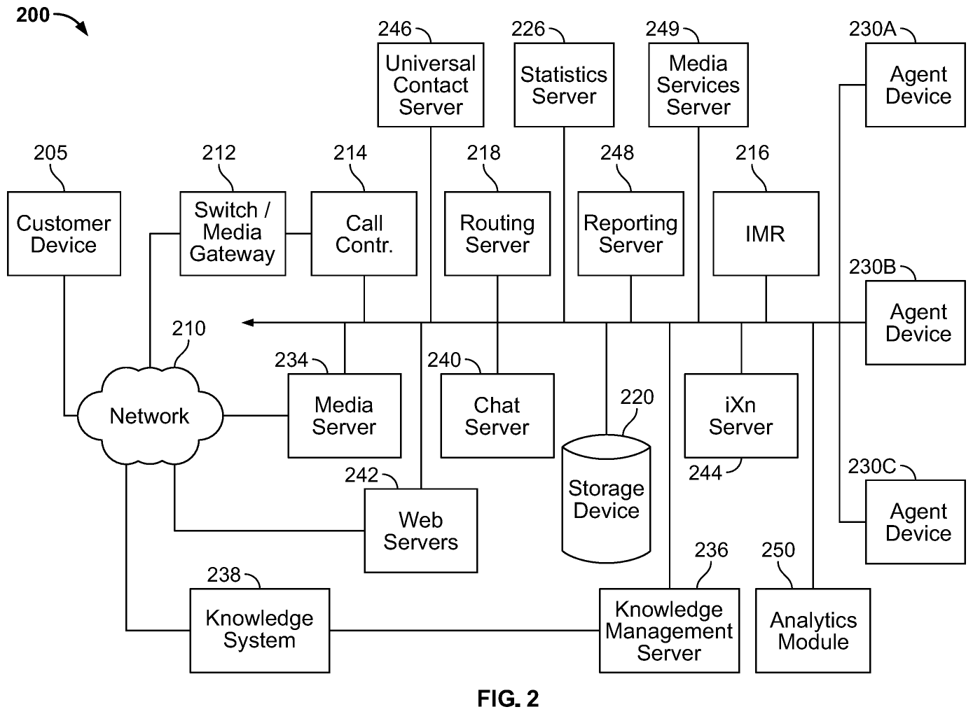

Unless otherwise specifically limited, the functionality described in relation to a plurality of computing devices may be integrated into a single computing device, or the various functionalities described in relation to a single computing device may be distributed across several computing devices. Further, in relation to the computing systems described herein—such as the contact center system 200 of FIG. 2—the various servers and computing devices thereof may be located on local computing devices 100 (e.g., on-site or on-premises at the same physical location as the agents of the contact center), remote computing devices 100 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

As shown in the illustrated example, the computing device 100 may include a central processing unit (CPU) or processor 105 and a main memory 110. The computing device 100 may also include a storage device 115, a removable media interface 120, a network interface 125, an input/output (I/O) controller 130, and one or more input/output (I/O) devices 135. For example, as depicted, the I/O devices 135 may include a display device 135A, a keyboard 135B, and/or a pointing device 135C. The computing device 100 may further include additional elements, such as a memory port 140, a bridge 145, one or more I/O ports, one or more additional input/output (I/O) devices 135D, 135E, 135F, and/or a cache memory 150 in communication with the processor 105.

The processor 105 may be any logic circuitry that responds to and processes instructions fetched from the main memory 110. For example, the processor 105 may be implemented by an integrated circuit (e.g., a microprocessor, microcontroller, or graphics processing unit), or in a field-programmable gate array (FPGA) or application-specific integrated circuit (ASIC). The processor 105 may include, or otherwise be embodied as, a high-power processor, an accelerator co-processor, or a storage controller. The main memory 110 may include, or otherwise be embodied as, any type of volatile (e.g., dynamic random access memory (DRAM), etc.) or non-volatile memory capable of storing data therein.

As depicted, the processor 105 may communicate directly with the cache memory 150 via a secondary bus or backside bus. It should be appreciated that the cache memory 150 typically has a faster response time than the main memory 110. The main memory 110 may be one or more memory chips capable of storing data and allowing stored data to be directly accessed by the processor 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices may include, for example, the keyboard 135B and the pointing device 135C (e.g., a mouse or optical pen). Output devices may include, for example, video display devices, speakers, and printers. The I/O devices 135 and/or the I/O controller 130 may include suitable hardware and/or software for enabling the use of multiple display devices. The computing device 100 may also support one or more removable media interfaces 120, such as a disk drive, USB port, or any other device suitable for reading data from or writing data to computer readable media. More generally, the I/O devices 135 may include any conventional devices for performing the functionality described herein.

The computing device 100 may be any workstation, desktop computer, laptop or notebook computer, server machine, virtualized machine, mobile or smart phone, portable telecommunication device, media playing device, gaming system, mobile computing device, or any other type of computing, telecommunications or media device, without limitation, capable of performing the operations and functionality described herein. Although described in the singular for clarity and brevity of the description, the computing device 100 may include a plurality of devices connected by a network or connected to other systems and resources via a network. As used herein, a network may be embodied as or include one or more computing devices, machines, clients, client nodes, client machines, client computers, client devices, endpoints, or endpoint nodes in communication with one or more other computing devices, machines, clients, client nodes, client machines, client computers, client devices, endpoints, or endpoint nodes. For example, the network may be embodied as or include a private or public switched telephone network (PSTN), wireless carrier network, local area network (LAN), private wide area network (WAN), public WAN such as the Internet, etc., with connections being established using appropriate communication protocols. More generally, it should be understood that, unless otherwise limited, the computing device 100 may communicate with other computing devices 100 via any type of network using any suitable communication protocol. Further, the network may be a virtual network environment where various network components are virtualized. For example, the various machines may be virtual machines implemented as a software-based computer running on a physical machine, or a “hypervisor” type of virtualization may be used where multiple virtual machines run on the same host physical machine. Other types of virtualization may be employed in other embodiments.

Referring now to FIG. 2, a simplified block diagram of at least one embodiment of a communications infrastructure and/or content center system, which may be used in conjunction with one or more of the embodiments described herein, is shown. The contact center system 200 may be embodied as any system capable of providing contact center services (e.g., call center services, chat center services, SMS center services, etc.) to an end user and otherwise performing the functions described herein. The illustrative contact center system 200 includes a customer device 205, a network 210, a switch/media gateway 212, a call controller 214, an interactive media response (IMR) server 216, a routing server 218, a storage device 220, a statistics server 226, agent devices 230A, 230B, 230C, a media server 234, a knowledge management server 236, a knowledge system 238, chat server 240, web servers 242, an interaction (iXn) server 244, a universal contact server 246, a reporting server 248, a media services server 249, and an analytics module 250. Although only one customer device 205, one network 210, one switch/media gateway 212, one call controller 214, one IMR server 216, one routing server 218, one storage device 220, one statistics server 226, one media server 234, one knowledge management server 236, one knowledge system 238, one chat server 240, one iXn server 244, one universal contact server 246, one reporting server 248, one media services server 249, and one analytics module 250 are shown in the illustrative embodiment of FIG. 2, the contact center system 200 may include multiple customer devices 205, networks 210, switch/media gateways 212, call controllers 214, IMR servers 216, routing servers 218, storage devices 220, statistics servers 226, media servers 234, knowledge management servers 236, knowledge systems 238, chat servers 240, iXn servers 244, universal contact servers 246, reporting servers 248, media services servers 249, and/or analytics modules 250 in other embodiments. Further, in some embodiments, one or more of the components described herein may be excluded from the system 200, one or more of the components described as being independent may form a portion of another component, and/or one or more of the components described as forming a portion of another component may be independent.

It should be understood that the term “contact center system” is used herein to refer to the system depicted in FIG. 2 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 200), the associated customer service provider (such as a particular customer service provider providing customer services through the contact center system 200), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VOIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 200 may be used by a customer service provider to provide various types of services to customers. For example, the contact center system 200 may be used to engage and manage interactions in which automated processes (or bots) or human agents communicate with customers. As should be understood, the contact center system 200 may be an in-house facility to a business or enterprise for performing the functions of sales and customer service relative to products and services available through the enterprise. In another embodiment, the contact center system 200 may be operated by a third-party service provider that contracts to provide services for another organization. Further, the contact center system 200 may be deployed on equipment dedicated to the enterprise or third-party service provider, and/or deployed in a remote computing environment such as, for example, a private or public cloud environment with infrastructure for supporting multiple contact centers for multiple enterprises. The contact center system 200 may include software applications or programs, which may be executed on premises or remotely or some combination thereof. It should further be appreciated that the various components of the contact center system 200 may be distributed across various geographic locations and not necessarily contained in a single location or computing environment.

It should further be understood that, unless otherwise specifically limited, any of the computing elements of the technologies described herein may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g.,

Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

It should be understood that any of the computer-implemented components, modules, or servers described in relation to FIG. 2 may be implemented via one or more types of computing devices, such as, for example, the computing device 100 of FIG. 1. As will be seen, the contact center system 200 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 200 may initiate inbound communications (e.g., telephone calls, emails, chats, etc.) to the contact center system 200 via a customer device 205. While FIG. 2 shows one such customer device—i.e., customer device 205—it should be understood that any number of customer devices 205 may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center system 200, such as telephone calls, emails, chats, text messages, web-browsing sessions, and other multi-media transactions.

Inbound and outbound communications from and to the customer devices 205 may traverse the network 210, with the nature of the network typically depending on the type of customer device being used and the form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 212 may be coupled to the network 210 for receiving and transmitting telephone calls between customers and the contact center system 200. The switch/media gateway 212 may include a telephone or communication switch configured to function as a central switch for agent level routing within the center. The switch may be a hardware switching system or implemented via software. For example, the switch 212 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. Thus, in general, the switch/media gateway 212 establishes a voice connection between the customer and the agent by establishing a connection between the customer device 205 and agent device 230.

As further shown, the switch/media gateway 212 may be coupled to the call controller 214 which, for example, serves as an adapter or interface between the switch and the other routing, monitoring, and communication-handling components of the contact center system 200. The call controller 214 may be configured to process PSTN calls, VOIP calls, and/or other types of calls. For example, the call controller 214 may include computer-telephone integration (CTI) software for interfacing with the switch/media gateway and other components. The call controller 214 may include a session initiation protocol (SIP) server for processing SIP calls. The call controller 214 may also extract data about an incoming interaction, such as the customer's telephone number, IP address, or email address, and then communicate these with other contact center components in processing the interaction.

The interactive media response (IMR) server 216 may be configured to enable self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. For example, a contact center for a bank may instruct customers via the IMR script to “press 1” if they wish to retrieve their account balance. Through continued interaction with the IMR server 216, customers may receive service without needing to speak with an agent. The IMR server 216 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment (e.g. Genesys® Designer).

The routing server 218 may function to route incoming interactions. For example, once it is determined that an inbound communication should be handled by a human agent, functionality within the routing server 218 may select the most appropriate agent and route the communication thereto. This agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described herein, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230. This information is intended to enhance the service the agent is able to provide to the customer.

It should be appreciated that the contact center system 200 may include one or more mass storage devices—represented generally by the storage device 220—for storing data in one or more databases relevant to the functioning of the contact center. For example, the storage device 220 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database. Agent data maintained by the contact center system 200 may include, for example, agent availability and agent profiles, schedules, skills, handle time, and/or other relevant data. As another example, the storage device 220 may store interaction data in an interaction database. Interaction data may include, for example, data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center system 200 in ways that facilitate the functionality described herein. For example, the servers or modules of the contact center system 200 may query such databases to retrieve data stored therein or transmit data thereto for storage. The storage device 220, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 226 may be configured to record and aggregate data relating to the performance and operational aspects of the contact center system 200. Such information may be compiled by the statistics server 226 and made available to other servers and modules, such as the reporting server 248, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center system 200 may be communication devices configured to interact with the various components and modules of the contact center system 200 in ways that facilitate functionality described herein. An agent device 230, for example, may include a telephone adapted for regular telephone calls or VOIP calls. An agent device 230 may further include a computing device configured to communicate with the servers of the contact center system 200, perform data processing associated with operations, and interface with customers via voice, chat, email, and other multimedia communication mechanisms according to functionality described herein. Although FIG. 2 shows three such agent devices 230—i.e., agent devices 230A, 230B and 230C—it should be understood that any number of agent devices 230 may be present in a particular embodiment.

The multimedia/social media server 234 may be configured to facilitate media interactions (other than voice) with the customer devices 205 and/or the servers 242. Such media interactions may be related, for example, to email, voice mail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 236 may be configured to facilitate interactions between customers and the knowledge system 238. In general, the knowledge system 238 may be a computer system capable of receiving questions or queries and providing answers in response. The knowledge system 238 may be included as part of the contact center system 200 or operated remotely by a third party. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials. As an example, the knowledge system 238 may be embodied as IBM Watson or a similar system.

The chat server 240 may be configured to conduct, orchestrate, and manage electronic chat communications with customers. In general, the chat server 240 is configured to implement and maintain chat conversations and generate chat transcripts. Such chat communications may be conducted by the chat server 240 in such a way that a customer communicates with automated chatbots, human agents, or both. In exemplary embodiments, the chat server 240 may perform as a chat orchestration server that dispatches chat conversations among the chatbots and available human agents. In such cases, the processing logic of the chat server 240 may be rules driven so to leverage an intelligent workload distribution among available chat resources. The chat server 240 further may implement, manage, and facilitate user interfaces (UIs) associated with the chat feature, including those UIs generated at either the customer device 205 or the agent device 230. The chat server 240 may be configured to transfer chats within a single chat session with a particular customer between automated and human sources such that, for example, a chat session transfers from a chatbot to a human agent or from a human agent to a chatbot. The chat server 240 may also be coupled to the knowledge management server 236 and the knowledge systems 238 for receiving suggestions and answers to queries posed by customers during a chat so that, for example, links to relevant articles can be provided.

The web servers 242 may be included to provide site hosts for a variety of social interaction sites to which customers subscribe, such as Facebook, Twitter, Instagram, etc.

Though depicted as part of the contact center system 200, it should be understood that the web servers 242 may be provided by third parties and/or maintained remotely. The web servers 242 may also provide webpages for the enterprise or organization being supported by the contact center system 200. For example, customers may browse the webpages and receive information about the products and services of a particular enterprise. Within such enterprise webpages, mechanisms may be provided for initiating an interaction with the contact center system 200, for example, via web chat, voice, or email. An example of such a mechanism is a widget, which can be deployed on the webpages or websites hosted on the web servers 242. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 244 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 244 may be configured to interact with the routing server 218 for selecting an appropriate agent to handle each of the deferrable activities. Once assigned to a particular agent, the deferrable activity is pushed to that agent so that it appears on the agent device 230 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 230 may include a workbin. As an example, a workbin may be maintained in the buffer memory of the corresponding agent device 230.

The universal contact server (UCS) 246 may be configured to retrieve information stored in the customer database and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 249 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 250 may be configured to provide systems and methods for performing analytics on data received from a plurality of different data sources as functionality described herein may require. In accordance with example embodiments, the analytics module 250 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the technologies described herein to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 250 may have access to the data stored in the storage device 220, including the customer database and agent database. The analytics module 250 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 250 may be configured to retrieve data stored within the storage device 220 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 250 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 250 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 2 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers in various embodiments. Further, the terms “interaction” and “communication” are used interchangeably, and generally refer to any real-time and non-real-time interaction that uses any communication channel including, without limitation, telephone calls (PSTN or VOIP calls), emails, vmails, video, chat, screen-sharing, text messages, social media messages, WebRTC calls, etc. Access to and control of the components of the contact system 200 may be affected through user interfaces (UIs) which may be generated on the customer devices 205 and/or the agent devices 230. As already noted, the contact center system 200 may operate as a hybrid system in which some or all components are hosted remotely, such as in a cloud-based or cloud computing environment. It should be appreciated that each of the devices of the call center system 200 may be embodied as, include, or form a portion of one or more computing devices similar to the computing device 100 described below in reference to FIG. 1.

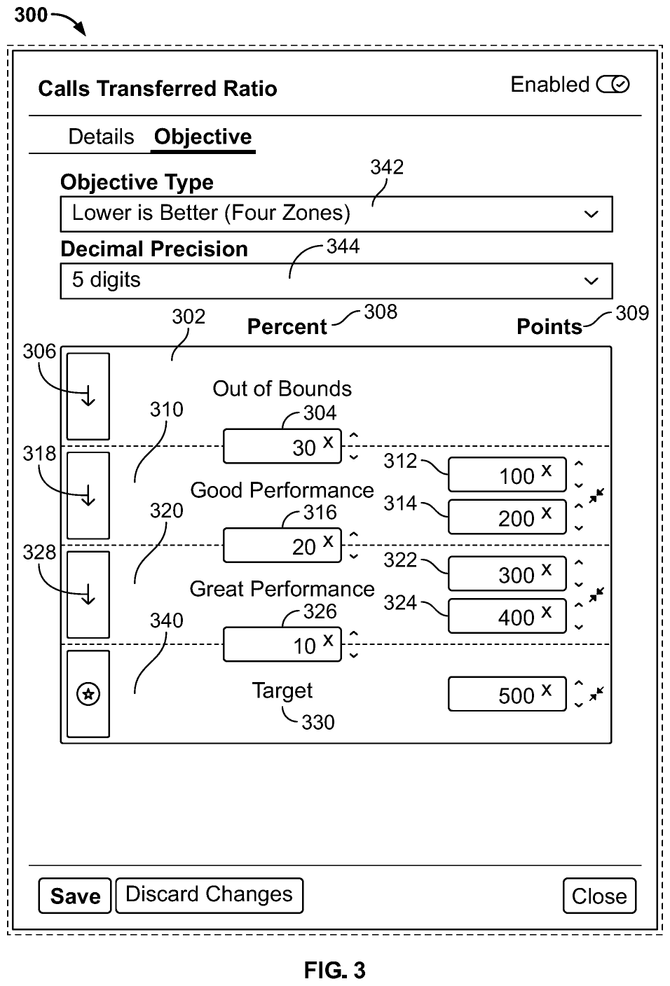

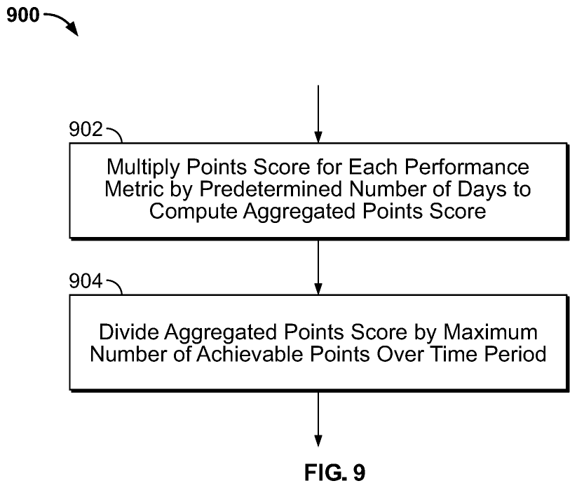

Referring now to FIGS. 3-10, an illustrative system (which may include or be embodied as the contact center system 200) for evaluating agent performance includes at least one processor (e.g., the processor 105) and at least one memory (e.g., the main memory 110 and/or cache memory 150) having instructions stored therein. Whether or not the subsequent reference in FIGS. 3-10 includes the corresponding numerical identifiers used in the figures previously described, it should be understood that the reference incorporates the example described in the previous figures and, unless otherwise specifically limited, may be implemented in accordance with either those examples or other technology capable of fulfilling the desired functionality, as would be understood by one of ordinary skill in the art. Thus, for example, subsequent mention of a “contact center system” should be understood as referring to the exemplary “contact center system 200” of FIG. 2 and/or other technologies for implementing a contact center system, at least in some embodiments.

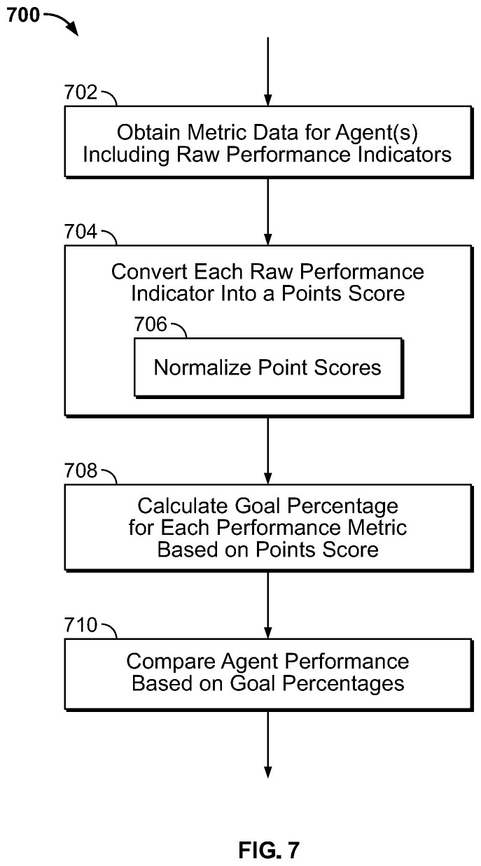

In the illustrative embodiment, in response to execution of the instructions stored in the memory by the at least one processor, the system performs the method 700 (see FIG. 7). In doing so, as described in greater detail below, the system (i) obtains (see block 702) metric data for one or more agents (e.g., agents of the contact center system 200) including raw performance indicators each corresponding to a particular agent performance metric of multiple agent performance metrics, (ii) converts (see block 704), based on the metric data, each of the raw performance indicators into a points score for the particular agent performance metric to provide multiple points scores for multiple agent performance metrics, (iii) calculates (see block 708), based on the points score, a goal percentage for each particular agent performance metric to provide multiple goal percentages for multiple agent performance metrics, and (iv) compares (see block 710), based on the multiple goal percentages, agent performance over the multiple agent performance metrics. In some embodiments, to convert each of the raw performance indicators into a points score, the system normalizes (see block 706) the points score for the particular agent performance metric across multiple variables to evaluate agent performance according to a common standard, as further discussed below.

In some cases, it may be difficult to accurately evaluate agent performance relative to the agent's own performance over time and relative to other agents or peers, especially when considering a variety of complicating factors. Those factors may include, but are not limited to, the amount of hours the agents work, the numerous roles/classifications of agents, objectives specific to the agent roles/classifications, and fluctuations in agent workload. In any case, agents or employees perform a multitude of daily tasks for which results may be measured to determine performance and compare performance among agents. For the purposes of the present disclosure, such results may be referred to as agent performance metrics. Agent performance metrics themselves, as well as the raw values or raw performance indicators (e.g., time, number, percentage, currency, etc.) used to assess performance for the performance metrics, may be widely variable.

As will be evident from the discussion that follows, the illustrative system provides various functionalities enabling agents to be grouped according to a common performance standard or expectation and normalizing agent performance based on that standard. As further discussed below, the system calculates goal percentages by looking at the total points score achieved by a particular agent over a particular time period and dividing the total points score by the maximum points achievable during that time period. The goal percentages calculated by the system provide a basis for holistic comparison of agent performance and may be relied upon to compare changes in agent performance relative to other agents/peers. The envisioned goal percentages provide single values for each agent performance metric over any time interval and thereby reduce the complexity of evaluating agent performance compared to other configurations. Advantageously, in some embodiments, the envisioned goal percentage values serve as gamification metrics to rate and evaluate agents, and those ratings and evaluations may be beneficial to encourage agent participation and stimulate competition among agents.

Referring now to FIGS. 3, 7, and 8, in use, the system (e.g., the contact center system 200) or a computing device (e.g., the computing device 100) may execute the method 700 to evaluate agent performance as mentioned above. It should be appreciated that the particular blocks of the method 700 are illustrated by way of example, and such blocks may be combined or divided, added or removed, and/or reordered in whole or in part depending on the particular embodiment, unless stated to the contrary.

In the illustrative embodiment, the method 700 begins with block 702. In block 702, the system obtains metric data for one of more agents from a data source, such as a library, lookup table, database, or other similar repository stored or maintained in memory (e.g., main memory 110). The metric data illustratively includes raw performance indicators (e.g., key performance indicators (KPIs)) each corresponding to a particular agent performance metric monitored over a predefined time interval. In one example, metric data obtained in block 702 is representative of one or more agent performance metrics measured over one day. In another example, metric data obtained in block 702 is measured over one week. In yet another example, metric data obtained in block 702 is measured over one month. In any case, in some embodiments, it should be appreciated that the raw performance indicators obtained in block 702 correspond to raw values of measurable agent performance characteristics that vary according to groupings and/or classifications of agents. Due to such variance, raw performance indicators obtained in block 702 represent non-normalized or substantially non-normalized raw values, at least in some embodiments. From block 702, the method proceeds to block 704.

In block 704 of the illustrative method 700, the system converts each of the raw performance indicators into a points score for the particular agent performance metric represented by the raw values. The system thereby provides or generates multiple points scores for multiple performance metrics in block 704. To do so, in the illustrative embodiment, the system performs block 706.

In block 706 of the illustrative method 706, the system normalizes the points score for each agent performance metric across a plurality of variables to evaluate agent performance according to a common standard. Such variables may include, but are not limited to, agent work status (e.g., full-time or part-time), agent work schedule (e.g., weekday or weekend work), agent skill requirements, agent experience level, agent age, and agent location. In some embodiments, that common standard may be applied to agents having similar classification statuses and/or skills requirements and establish a basis for evaluating and/or grouping agents together to facilitate gamification. In the illustrative embodiment, to perform block 706, the system performs the method 800.

In use, the system (e.g., the contact center system 200) or a computing device (e.g., the computing device 100) executes the method 800 to normalize the points score for each agent performance metric. It should be appreciated that the particular blocks of the method 800 are illustrated by way of example, and such blocks may be combined or divided, added or removed, and/or reordered in whole or in part depending on the particular embodiment, unless stated to the contrary. As will be apparent from the discussion that follows, the blocks of the method 800 are described below in connection with a display or visualized representation 300 shown in FIG. 3. In some embodiments, the display 300 may be included in, or otherwise form a portion of, a graphical user interface.

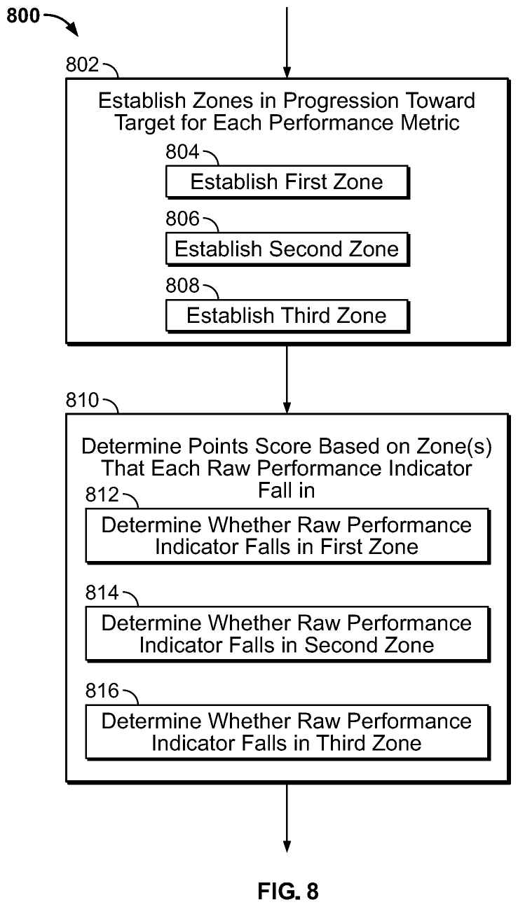

The illustrative method 800 begins with block 802 in which the system establishes multiple gamification zones or points. More specifically, in each of the embodiments depicted in FIGS. 3 and 8, the system establishes multiple gamification zones in progression toward a target for the conversion of the raw performance indicators corresponding to each agent performance metric into the points score. As discussed below, the points score is illustratively determined based on the particular gamification zone that the key performance indicator(s) for a particular agent performance metric falls or resides in. Of course, it should be appreciated that in some cases, the key performance indicator(s) may reside in between and/or overlap gamification zones. In any case, in the illustrative embodiment of FIG. 8, to perform block 802, the system performs block 804, 806, 808.

In block 804 of the illustrative method 800, the system establishes a first gamification zone corresponding to a first points score for one or more raw performance indicators of a particular agent performance metric. One example of the first gamification zone is the zone 302 shown in FIG. 3. In the illustrative example, the zone 302 represents an out-of-bounds zone corresponding to a score of zero points (see the points column 309). In some embodiments, the zone 302 may correspond to a null value for a particular agent performance metric, and a zero points score or null value may indicate that one or more raw performance indicators for a particular agent performance metric have not been obtained by the system. The zone 302 includes a threshold value 304 (e.g., 30) for progression to the next zone as indicated by the arrow 306. Although the threshold value 304 is illustrated as a percentage in the percent column 308, it should be appreciated that the threshold value 304 may include, or otherwise be embodied as, any unit of measurement for one or more raw performance indicators.

In block 806 of the illustrative method 800, the system establishes a second gamification zone corresponding to a second points score for one or more raw performance indicators of a particular agent performance metric. One example of the second gamification zone is the zone 310 shown in FIG. 3. In the illustrative example, the zone 310 is closer to the target value 330 than the zone 302 and the second points score is greater than the first points score. In the illustrative embodiment, the second points score encompasses or includes a point score range having a lower limit 312 (e.g., 100) and an upper limit 314 (e.g., 200). In some embodiments, raw performance indicator(s) that fall in the zone 310 correspond to a points score between the lower limit 312 and the upper limit 314. The zone 310 includes a threshold value 316 (e.g., 20) for progression to the next zone as indicated by the arrow 318. Although the threshold value 316 is illustrated as a percentage in the percent column 308, it should be appreciated that the threshold value 316 may include, or otherwise be embodied as, any unit of measurement for one or more raw performance indicators.

In block 808 of the illustrative method 800, the system establishes a third gamification zone corresponding to a third points score for one or more raw performance indicators of a particular agent performance metric. One example of the third gamification zone is the zone 320 shown in FIG. 3. In the illustrative example, the zone 320 is closer to the target value 330 than the zone 310 and the third points score is greater than the second points score. In the illustrative embodiment, the third points score encompasses or includes a point score range having a lower limit 322 (e.g., 300) and an upper limit 324 (e.g., 400). In some embodiments, raw performance indicator(s) that fall in the zone 320 correspond to a points score between the lower limit 322 and the upper limit 324. The zone 320 includes a threshold value 326 (e.g., 10) for progression to the target value 330 as indicated by the arrow 328. Although the threshold value 326 is illustrated as a percentage in the percent column 308, it should be appreciated that the threshold value 326 may include, or otherwise be embodied as, any unit of measurement for one or more raw performance indicators.

In the illustrative embodiment, the target value 330 corresponds to the maximum points (e.g., 500) achievable for the particular agent performance metric. In some embodiments, in addition to the zones 302, 310, 320, the system may establish a fourth gamification zone 340 corresponding to a fourth points score for one or more raw performance indicators of a particular agent performance metric that is greater than the third points score. In those embodiments, the gamification zone 340 may be defined by the target value 330 and raw performance indicator(s) that fall in the zone 340 correspond to the maximum possible points.

The illustrative method 800 proceeds from block 802 to block 810. In block 810, the system determines the points score for the particular agent performance metric based on the zone or zones that the corresponding raw performance indicator falls in. To do so, the system illustratively performs blocks 812, 814, 816. In block 812, the system determines whether the raw performance indicator(s) for the particular agent performance metric fall in the zone 302. In block 814, the system determines whether the raw performance indicator(s) for the particular agent performance metric fall in the zone 310. In block 816, the system determines whether the raw performance indicator(s) for the particular agent performance metric fall in the zone 320. In some embodiments, in block 810, the system may determine whether the raw performance indicator(s) for the particular agent performance metric fall in the zone 340.

It should be appreciated that the gamification zones 302, 310, 320, 340 provide the foundation for normalizing agent performance for each agent performance metric and converting the raw performance indicators into points scores. The zones 302, 310, 320 establish a progression toward the target value 330. An agent receives the maximum number of points when the raw performance indicator(s) for a particular performance metric fall within the zone 340 as mentioned above.

Referring back to FIG. 7, from block 704, the illustrative method 700 proceeds to block 708. In block 708, following the aforementioned conversion in block 704, the system calculates a goal percentage for each agent performance metric based on the points score. To do so, in the illustrative embodiment, the system performs the method 900.

In use, the system (e.g., the contact center system 200) or a computing device (e.g., the computing device 100) executes the method 900 to calculate the goal percentage for each agent performance metric. It should be appreciated that the particular blocks of the method 900 are illustrated by way of example, and such blocks may be combined or divided, added or removed, and/or reordered in whole or in part depending on the particular embodiment, unless stated to the contrary.

The illustrative method 900 begins with block 902. In block 902, the system multiplies the points score for each agent performance metric by a predetermined number of days to compute an aggregated points score for each metric over the predetermined time interval. In one example, the points score for a particular agent performance metric is determined over a period of one day, and the points score is multiplied by five to compute the aggregated points score for the metric over one five-day work week (e.g., for weekday agents). In another example, the points score for a particular agent performance metric is determined over a period of one day, and the points score is multiplied by the number of workdays in the present month to compute the aggregated points score for the metric over the present month. In yet another example, the points score for a particular agent performance metric is determined over a period of one day, and the points score is multiplied by the number of workdays in a previous month to compute the aggregated points score for the metric over the previous month. In any case, from block 902, the method 900 proceeds to block 904.

In block 904 of the illustrative method 900, the system divides the aggregated points score for each agent performance metric by the maximum number of points achievable for the particular metric over the predetermined time interval to calculate a quotient (e.g., a fractional quotient). Additionally, in block 904, the system multiples the calculated quotient by 100 to determine the goal percentage for the particular performance metric.

In one example of performing the illustrative method 900, the system defines the maximum achievable points score (e.g., the target value 330) for a particular agent performance metric to be 500 points. Over the course of a five-day work week (e.g., for agent(s) working weekdays), a total of 2500 points (i.e., 500×5) are achievable. An agent obtains an aggregated points score of 1567 points for the particular performance metric over the five-day work week. The system divides the aggregated points score by the maximum achievable points and multiplies the quotient by 100 to determine a goal percentage of 62.68% for the particular performance metric for the agent. In some examples, the goal percentages for a given metric over multiple weeks may be normalized based on the number of days worked in those weeks.

Using the previous example, if the agent achieves an 80% goal percentage in the next week following the week in which the 62.68% percentage is achieved, that represents a 17.32% improvement in goal percentage for the particular agent performance metric.

Returning to FIG. 7, from block 708, the illustrative method 700 proceeds to block 710. In block 710, following the aforementioned calculation of goal percentages in block 708, the system compares agent performance over one or more agent performance metrics based on the goal percentages calculated for those metrics. To do so, in the illustrative embodiment, the system performs the method 1000.

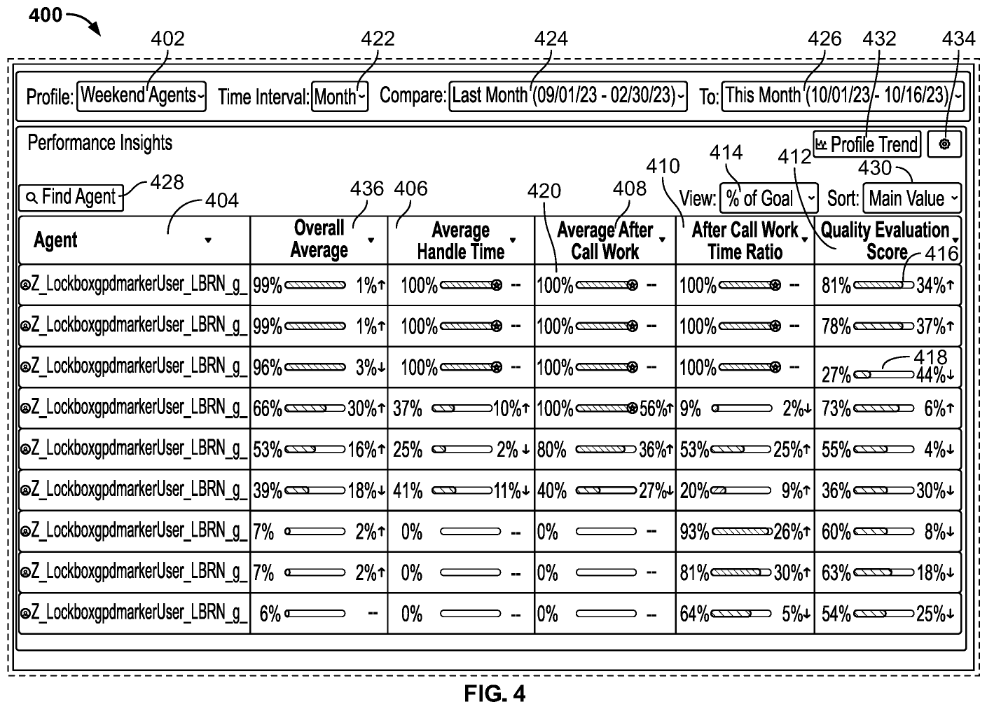

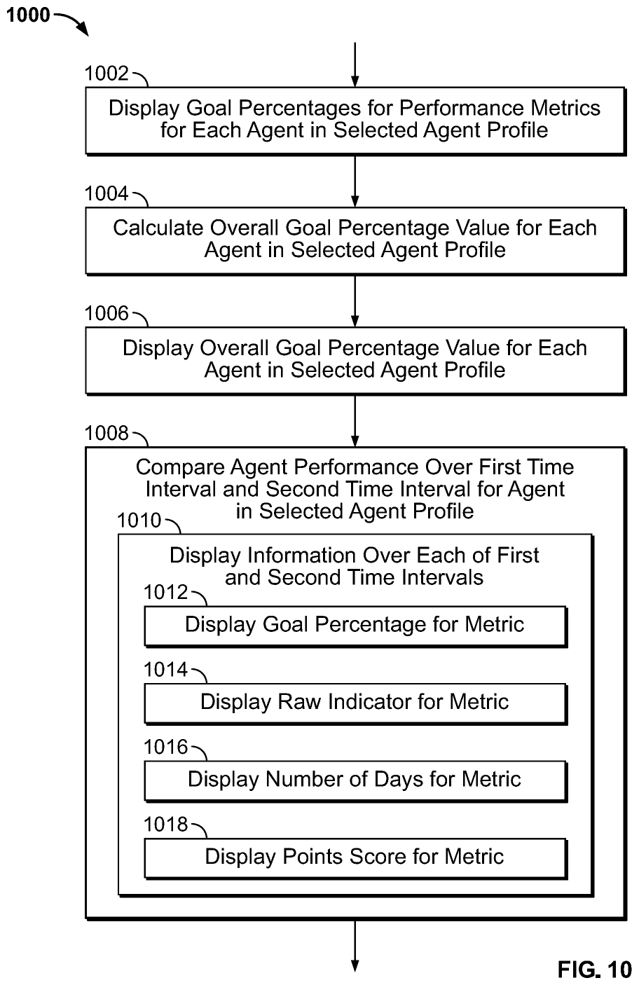

Referring now to FIG. 10, in use, the system (e.g., the contact center system 200) or a computing device (e.g., the computing device 100) executes the method 1000 to compare agent performance over one or more performance metrics. It should be appreciated that the particular blocks of the method 1000 are illustrated by way of example, and such blocks may be combined or divided, added or removed, and/or reordered in whole or in part depending on the particular embodiment, unless stated to the contrary. As will be apparent from the discussion that follows, the blocks of the method 1000 are described below in connection with a display or visualized representation 400 shown in FIG. 4. In some embodiments, the display 400 may be included in, or otherwise viewed with, a graphical user interface.

The illustrative method 1000 begins with block 1002. In block 1002, the system generates and displays goal percentages for various performance metrics specific or applicable to each agent in a selected agent profile to facilitate visualized comparison of agent performance across the selected profile. The agent profile panel 402 allows a particular agent profile (e.g., weekend agents) to be input or selected. Various agents in the agent profile are identified in an agent listing column 404. Columns 406, 408, 410, 412 correspond to distinct performance metrics for each agent in the agent profile. As indicated by a view panel 414, values displayed in the columns 406, 408, 410, 412 correspond to goal percentages calculated for the listed agents in the selected agent profile. In the illustrative example, the column 406 is labeled as “Average Handle Time,” the column 408 is labeled as “Average After Call Work,” the column 410 is labeled as “After Call Work Time Ratio,” and the column 412 is labeled as “Quality Evaluation Score.”

In each of the columns 406, 408, 410, 412, goal percentages may be displayed for the listed agents with or without arrows indicating percentage increase (i.e., designated with an arrow pointing up) or percentage decrease (i.e., designated with an arrow pointing down) of the values relative to values from a previous time period (e.g., a previous month). In one example, goal entry 416 includes a goal percentage value (81%) and an arrow indicating a percentage increase (34%) for that value relative to the value from the previous month. In another example, goal entry 418 includes a goal percentage value (27%) and an arrow indicating a percentage decrease (44%) for that value relative to the value from the previous month. In yet another example, goal entry 420 includes a goal percentage value (100%) and does not contain an arrow indicating a percentage increase or decrease.

The illustrative display 400 includes a time interval panel 422 allowing a particular time interval (e.g., a month) to be input or selected. Additionally, the display 400 includes a comparison panel 424 (labeled “compare” in FIG. 4) and a comparison panel 426 (labeled “to” in FIG. 4) each allowing a time interval to be input or selected so that performance metrics over one time period may be compared to performance metrics over another time period. The display 400 includes an agent search panel 428 allowing a search to be performed based on agent identification information (e.g., the agent's name) that is input or selected. The display 400 also includes a sort panel 430 allowing results to be sorted based on an input or selected factor (e.g., a sequence, display order, etc.), a profile trend panel 432 that may be used to input, select, and/or generate trend data (e.g., in the form of charts, graphs, or the like) for a particular agent profile and/or set of agent performance metrics, and a settings panel 434 that may be used to input and/or adjust settings (e.g., for a particular agent profile).

As evident from the display 400 illustrated in FIG. 4, the goal percentages generated and displayed by the system in block 1002 normalize metric data across a variety of variables in order to compare agent or employee performance at a glance. By selecting the agent profile via the agent profile panel 402, all employees or agents are grouped based on the same agent performance metrics and associated goal percentages.

From block 1002 of the illustrative method 1000, the method 1000 proceeds to block 1004. In block 1004, the system calculates, for each agent in the selected agent profile, an overall goal percentage value corresponding to an average of the goal percentages for the set of performance metrics assigned or applicable to the particular agent. In some embodiments, the overall goal percentage value is representative of overall performance of the agent and takes into account the agent's performance across the applicable performance metrics. Additionally, in some embodiments, the overall goal percentage value provides a single performance metric that may figure largely in the evaluation of agent performance. From block 1004, the method 1000 proceeds to block 1006.

In block 1006 of the illustrative method 1000, the system displays, for each agent in the selected agent profile, the overall goal percentage to facilitate visualized comparison of overall goal percentage value across the selected agent profile. The illustrative display 400 includes a column 436 labeled “Overall Average” in which the overall goal percentage values are displayed for each agent in the selected profile. In some embodiments, the system may consolidate blocks 1004, 1006 into a single step or block. In any case, from block 1006, the method 1000 proceeds to block 1008.

In block 1008 of the illustrative method 1000, the system compares agent performance over predefined time intervals for the agents in a selected agent profile. More specifically, at least in some embodiments, the system compares agent performance in a selected agent profile based on information input via the comparison panels 424, 426. In the illustrative example of FIG. 4, results for the previous month are specified via the comparison panel 424 and results for the current month are specified via the comparison panel 426.

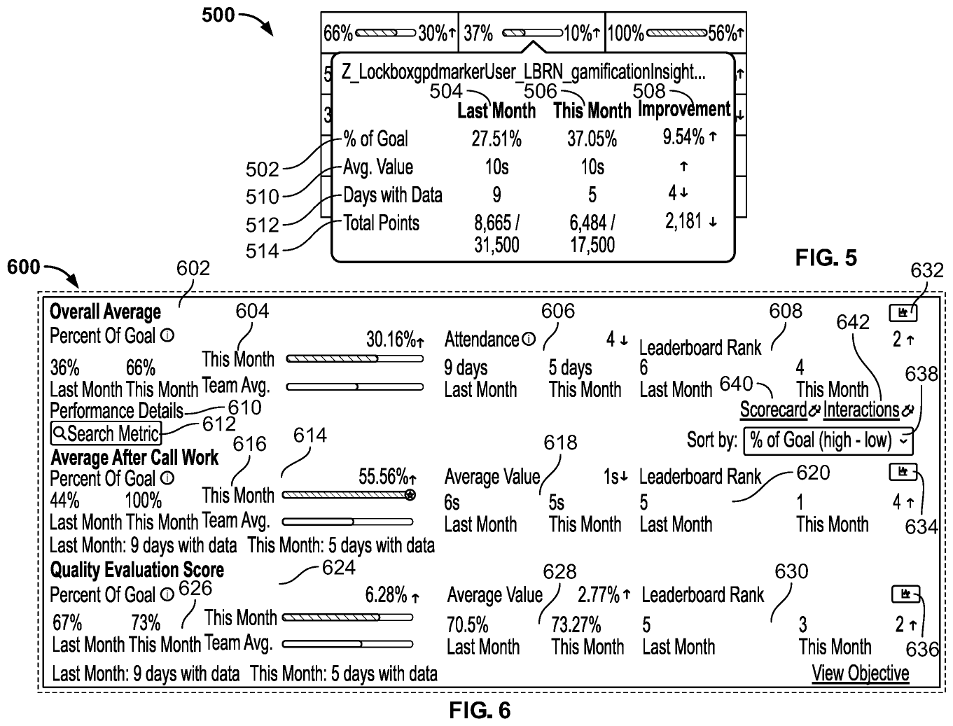

In the illustrative embodiment, to perform block 1008, the system performs block 1010. In block 1010, the system displays information for a particular performance metric for an agent in a selected agent profile over each of the time intervals input via the comparison panels 424, 426. One illustrative example of the information displayed in block 1010 is shown in the display or visualized representation 500 (see FIG. 5). In some embodiments, the system displays information in block 1010 in response to the selection (e.g., hovering over a table cell) of a particular entry (e.g., a particular entry in one of the columns 406, 408, 410, 412, 436) for a particular agent in the selected agent profile.

In the illustrative embodiment, to perform block 1010, the system performs blocks 1012, 1014, 1016, 1018. In block 1012, the system displays the goal percentage for the performance metric associated with the particular goal entry. In the illustrative example shown in FIG. 5, the display 500 includes a goal percentage row 502 in which goal percentage information for the particular performance metric is displayed. The information displayed in the goal percentage row 502 includes the goal percentage value for the previous month (values for the previous month are presented in column 504), the goal percentage value for the current month (values for the current month are presented in column 506), and the percentage of improvement (or lack thereof) in the goal percentage value from the previous month to the current month (values for the improvement are presented in column 508).

In block 1014, the system displays the one or more raw performance indicators for the performance metric associated with the particular goal entry. In the illustrative example shown in FIG. 5, the display 500 includes an average value row 510 in which an average value for the raw performance indicator(s) associated with the particular goal entry is displayed. The information displayed in the average value row 510 includes the average value of the raw performance indicator(s) for the previous month, the average value of the raw performance indicator(s) for the current month, and the percentage of improvement (or lack thereof) in the average value of the raw performance indicator(s) from the previous month to the current month.

In block 1016, the system displays the total number of days over which data for the performance metric associated with the particular goal entry has been obtained. In the illustrative example shown in FIG. 5, the display 500 includes a days with data row 512 in which the number of days that data has been obtained for the performance metric is displayed. The information displayed in the days with data row 512 includes the number of days with data for the previous month, the number of days with data for the current month, and the percentage of improvement (or lack thereof) in the number of days with data from the previous month to the current month.

In block 1018, the system displays the total number of points for the performance metric associated with the particular goal entry. In the illustrative example shown in FIG. 5, the display 500 includes a points row 514 in which the number of total points for the performance metric is displayed. The information displayed in the points row 514 includes the points for the previous month, the points for the current month, and the percentage of improvement (or lack thereof) in the points from the previous month to the current month. In the illustrative embodiment, points for the previous month and the current month are displayed in the points row 514 next to the maximum points achievable in the given month for that metric.

Referring now to FIG. 6, in the illustrative embodiment, a display or visualized representation 600 may be generated and/or displayed by the system in response to the selection of a particular agent in the agent listing column 404. The illustrative display 600 provides detailed information regarding the performance (e.g., the applicable goal percentages) of the selected agent.

In the illustrative embodiment, the display 600 includes an overall goal percentage value pane 602 that provide detailed information regarding the overall goal percentage value for the selected agent. The overall goal percentage value pane 602 includes a goal percentage panel 604, an attendance panel 606, and a leaderboard panel 608. The goal percentage panel 604 provides a visual indication of the selected agent's overall goal percentage value for the previous month, the selected agent's overall goal percentage value for the current month, and the selected agent's goal percentage value improvement (or decline) from the current month relative to the previous month. The attendance panel 606 provides a visual indication of the number of days during the previous month in which the selected agent's attendance or participation was recorded (e.g., based on metric data obtained for the agent over that month), the number of days during the current month in which the selected agent's attendance or participation was recorded, and the increase (or decrease) in the number of days in which the selected agent's attendance has been recorded from the current month relative to the previous month. The leaderboard panel 608 provides a visual indication of the selected agent's rank or rating relative to other agents in the agent profile (e.g., based on the overall goal percentage value) for the previous month, the selected agent's rank or rating relative to other agents in the agent profile for the current month, and the increase (or decrease) in the selected agent's rank from the current month to the previous month.

The illustrative display 600 includes a performance details pane 610 that provides performance details for performance metrics applicable to the selected agent aside from the overall goal percentage value. The details pane 610 includes a metric search panel 612 that allows the performance metrics for the particular agent to be searched and/or queried. In the illustrative embodiment, the details pane 610 includes a first metric panel 614 (labeled as “Average After Call Work” in FIG. 6) and a second metric panel 624 (labeled as “Quality Evaluation Score” in FIG. 6). Although the details pane 610 illustratively includes two metric panels corresponding to two performance metrics, it should be appreciated that the details pane 610 may include another suitable number of metric panels corresponding to another suitable number of performance metrics, at least in some embodiments.

The illustrative metric panel 614 includes a goal percentage panel 616, an average value panel 618, and a leaderboard panel 620. The goal percentage panel 616 provides a visual indication of the selected agent's goal percentage value for the particular metric over the previous month, the selected agent's goal percentage value for the particular metric over the current month, and the selected agent's goal percentage value improvement (or decline) from the current month relative to the previous month. The average value panel 618 provides a visual indication of the selected agent's raw performance indicator(s) for the particular performance metric (e.g., based on metric data obtained for the agent over that month) over the previous month, the selected agent's raw performance indicator(s) for the particular performance metric over the previous month, and the increase (or decrease) in the selected agent's raw performance indicator(s) for the particular metric from the current month relative to the previous month. The leaderboard panel 620 provides a visual indication of the selected agent's rank or rating relative to other agents in the agent profile (e.g., based on the goal percentage value for the particular metric) for the previous month, the selected agent's rank or rating relative to other agents in the agent profile for the current month, and the increase (or decrease) in the selected agent's rank from the current month to the previous month.

The illustrative metric panel 624 includes a goal percentage panel 626, an average value panel 628, and a leaderboard panel 630. The goal percentage panel 626 provides a visual indication of the selected agent's goal percentage value for the particular metric over the previous month, the selected agent's goal percentage value for the particular metric over the current month, and the selected agent's goal percentage value improvement (or decline) from the current month relative to the previous month. The average value panel 628 provides a visual indication of the selected agent's raw performance indicator(s) for the particular performance metric (e.g., based on metric data obtained for the agent over that month) over the previous month, the selected agent's raw performance indicator(s) for the particular performance metric over the previous month, and the increase (or decrease) in the selected agent's raw performance indicator(s) for the particular metric from the current month relative to the previous month. The leaderboard panel 630 provides a visual indication of the selected agent's rank or rating relative to other agents in the agent profile (e.g., based on the goal percentage value for the particular metric) for the previous month, the selected agent's rank or rating relative to other agents in the agent profile for the current month, and the increase (or decrease) in the selected agent's rank from the current month to the previous month.

The illustrative display 600 includes a trend panel 632 that may be selected to generate and/or display trend data (e.g., in the form of charts, graphs, or the like) based on the information contained in the overall goal percentage value pane 602. The display 600 illustratively includes a trend panel 634 that may be selected to generate and/or display trend data (e.g., in the form of charts, graphs, or the like) based on the information contained in the metric panel 614. The display 600 illustratively includes a trend panel 636 that may be selected to generate and/or display trend data (e.g., in the form of charts, graphs, or the like) based on the information contained in the metric panel 624.

The illustrative display 600 includes a sort panel 638 allowing results to be sorted based on an input or selected factor (e.g., a sequence or display order according to goal percentage value) for the metric panes 614, 624. The display 600 includes a scorecard feature 640 and an interactions feature 642 that may be selected to provide further insights for evaluating agent performance.

In some embodiments, performance metric data visualized from the displays 400, 500, 600 may be aggregated and stored daily for the current day, week, or month for all agents or employees. In such embodiments, performance metric data may be retrieved in a rapid manner. Amazon Web Services (AWS) technologies (e.g., Amazon S3) may be utilized to provide object storage in conjunction with other library services (e.g., Python Pandas) utilized for data manipulation and analysis.

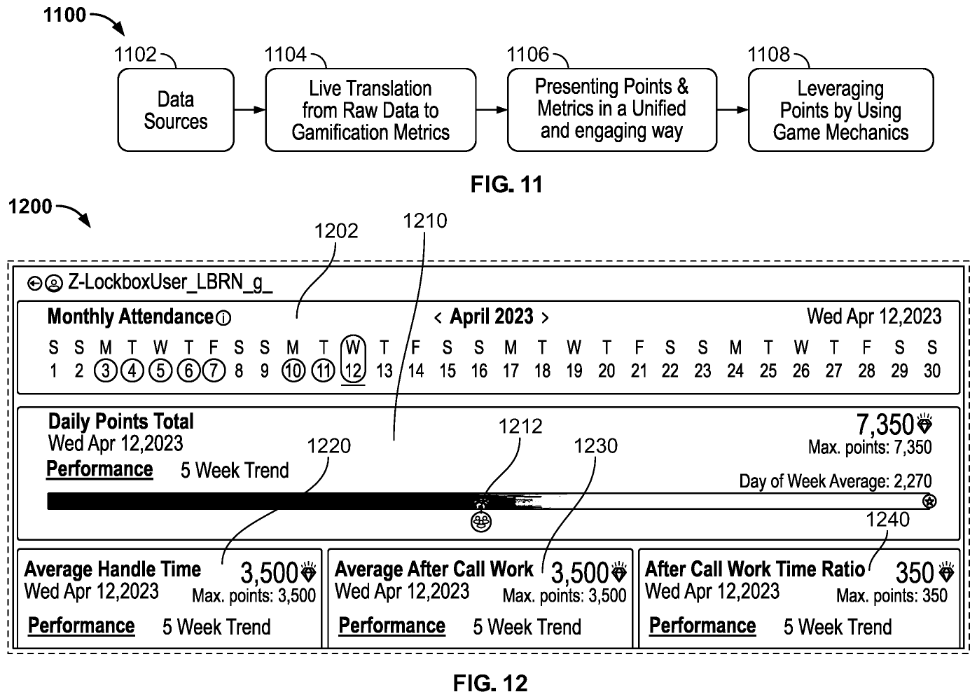

Referring now to FIG. 11, in some embodiments, the system (e.g., the computing device 100 or the contact center system 200) may perform a method or flow 1100 to evaluate agent performance based on gamification metrics. It should be appreciated that the particular blocks of the method 1100 are illustrated by way of example, and such blocks may be combined or divided, added or removed, and/or reordered in whole or in part depending on the particular embodiment, unless stated to the contrary. In any case, for the purposes of the present disclosure, it should be appreciated that gamification may be a tool for converting raw analytical data into gamification points in a unique and/or useful manner. The raw data may be received from internal and external services to calculate points and values against agent performance metrics. In some embodiments, gamification metrics may be key performance indicators (KPIs) that use a definition to calculate a metric value along with ranges of points and values (e.g., zones) in order to create objectives for agents. The agent objectives may be defined by zones and used to translate metric values into points scores by a performance management administrator. Additionally, in some embodiments, game mechanics may be used in conjunction with the awarded points scores to engage and motivate agents or employees to achieve their own goals as well as the goals of the business.

In the illustrative embodiment, the method 1100 begins with block 1102. In block 1102, the system gathers metric data from one or more data sources. The one or more data sources may be disparate systems capable of tracking agent performance based on such factors as client interaction, schedule adherence, and other qualitative and/or quantitative metrics. In some embodiments, metric data gathered from the one or more data sources may include, but is not limited to, (i) interaction metrics (e.g., handle time, on hold time, after interaction wrap up time, interactions handled per hour, total interaction time, percentage of interactions transferred and not handled, etc.), (ii) schedule adherence metrics (e.g., punctuality based on assigned shifts, overall conformance to schedule, and schedule adherence calculated by workforce management), (iii) quality metrics (e.g., supervisor evaluations, client evaluations, self-evaluations, automated evaluations through voice transcription and topic detection, sentiment analysis or empathy analysis of voice or digital transcripts), and (iv) quantitative metrics (e.g., daily sales, daily orders placed, leads generated, visits booked, average retention rate, refund rate, etc.). In any case, from block 1102, the method 1100 proceeds to block 1104.

In block 1104 of the illustrative method 1100, the system translates the gathered performance metric data into defined gamification metrics. In some embodiments, to perform block 1104, the system unifies calculated metric values to indicate performance levels and awards points. Since performance expectations may vary drastically from one metric to another, gamification metrics allow users to define the set of metrics of interest for different employee populations and subsequently define the range of performance levels (e.g., zones) for each metric that will indicate employee performance. In some embodiments, to configure a gamification metric's objective, an objective type is selected using an objective selection tab 342 (see FIG. 3) and the decimal precision (e.g., for the raw performance indicator(s)) is selected using a decimal precision tab 344. The objective type may determine the number of zones and/or the direction (e.g., lower is better) in progression toward a target value (e.g., the target value 330). In some embodiments, each zone (e.g., each of the zones 302, 310, 320, 340) may have a distinct label and color corresponding to a particular performance level (e.g., out of bounds, good, great, target). Additionally, in some embodiments, it is up to the performance management administrator to set the value thresholds for each zone as well as the number of points for each zone. In some cases, the administrator may choose a linearly increasing range of awarded points within each zone or a single points value for each zone. In any case, from block 1104, the method 1100 proceeds to block 1106.

In block 1106 of the illustrative method 1100, the system generates and displays a scorecard 1200 (see FIG. 12) that permits real-time and/or continuous evaluation of employee or agent performance and facilitates presentation of agent performance metrics and objectives in a unified and engaging manner for visibility and transparency. It should be appreciated that the scorecard 1200 may be provide a daily live report of agent performance translated into points scores for the particular's agents performance metrics over a given day. Points may be awarded or withdrawn on a near real-time or continuous basis for each defined performance metric used to evaluate an agent's performance. In this manner, the scorecard 1200 may be used to compare, motivate, incentivize, reward, and improve employee performance.

The illustrative scorecard 1200 includes a monthly attendance pane 1202, a daily points total pane 1210, a first metric score panel 1220, a second metric score panel 1230, and a third metric score panel 1240. The monthly attendance pane 1202 indicates the days of the month that agent attendance or participation has been tracked or recorded for the particular agent. The daily points total pane 1210 indicates the combined total points achievable daily across the performance metrics applicable to the particular agent. The actual points achieved by the particular agent for the day in question are illustrated by a points indicator 1212 shown in the daily points total pane 1210. The first metric score panel 1220 indicates the maximum points achievable daily for a first performance metric (labeled as “Average Handle Time”) applicable to the selected agent. The second metric score panel 1230 indicates the maximum points achievable daily for a second performance metric (labeled as “Average After Call Work”) applicable to the selected agent. The third metric score panel 1240 indicates the maximum points achievable daily for a third performance metric (labeled as “After Call Work Time Ratio”) applicable to the selected agent. The points total indicated in the daily points total pane 1210 represents the sum of the points indicated in the score panels 1220, 1230, 1240.

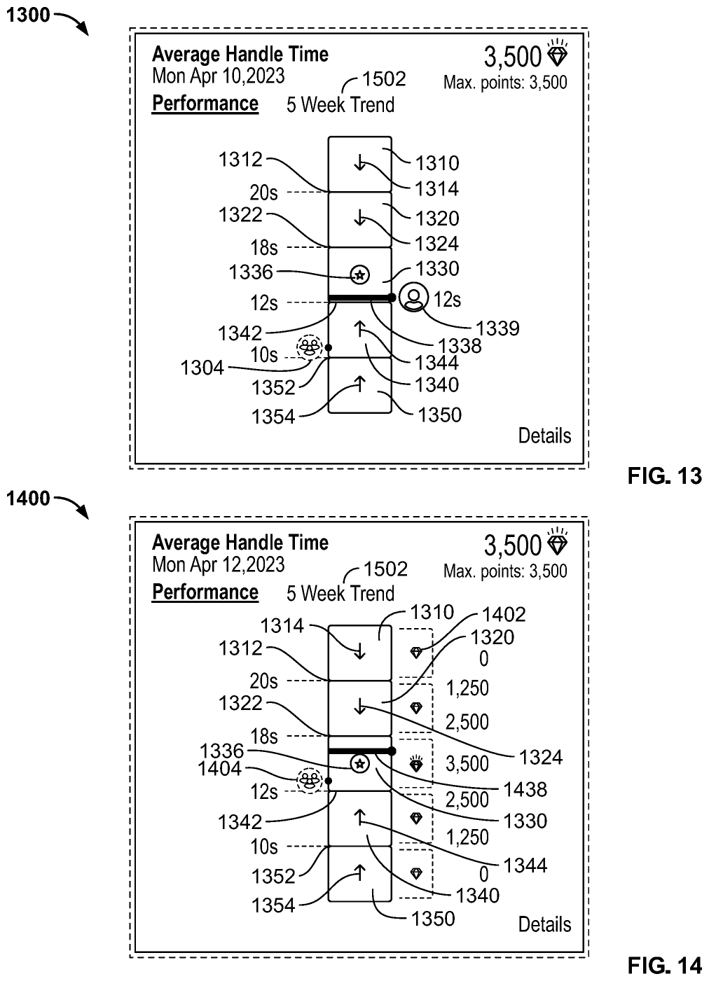

As shown in FIGS. 13 and 14, respective displays or visualized representations 1300, 1400 may be generated and displayed in response to selecting or hovering a cursor over the metric score panel 1220 (note that each display 1300, 1400 is labeled “Average Handle Time”). In some embodiments, the display 1400 may be generated and displayed in response to selecting, or hovering a cursor over, one of the gamification zones depicted in FIG. 13. In any case, each of the illustrative displays 1300, 1400 includes gamification zones 1310, 1320, 1330, 1340, 1350. The points score or points score range corresponding to each gamification zone 1310, 1320, 1330, 1340, 1350 are illustrated in FIG. 14, whereas the gamification zones 1310, 1320, 1330, 1340, 1350 are depicted without the corresponding points scores in FIG. 13.

In the illustrative embodiment, the zone 1310 corresponds to a points score of zero points (see FIG. 14). In some embodiments, the zone 1310 may correspond to a null value for a particular agent performance metric, and a zero points score or null value may indicate that one or more raw performance indicators for the particular agent performance metric have not been obtained by the system. The zone 1310 includes a threshold value 1312 (e.g., 20 seconds) for progression to the next zone as indicated by the arrow 1314.

In the illustrative embodiment, the zone 1320 corresponds to a points score of between 1,250 and 2,500 points (see FIG. 14). The zone 1320 is located in closer proximity to the target zone 1330 than the zone 1310. The zone 1320 includes a threshold value 1322 (e.g., 18 seconds) for progression to the next zone as indicated by the arrow 1324.

In the illustrative embodiment, the zone 1330 is the target zone corresponding to the maximum points achievable (e.g., 3500 points) for the performance metric. In some embodiments, a star 1336 is located within the target zone 1330, and when the raw performance indicator(s) for the particular performance metric falls in the target zone 1330, the star 1336 and/or the zone 1330 may be colored or illuminated to indicate the maximum points achieved. As shown in FIG. 13, a line 1338 corresponds to a raw performance indicator (e.g., 12 seconds) that falls in the target zone 1330, and an avatar 1339 for the particular agent or employee is displayed next to the line 1338. As shown in FIG. 14, a line 1438 corresponds to a raw performance indicator that falls in the target zone 1330.

In the illustrative embodiment, the zone 1350 corresponds to a points score of zero points (see FIG. 14). In some embodiments, the zone 1350 may correspond to a null value for a particular agent performance metric, and a zero points score or null value may indicate that one or more raw performance indicators for the particular agent performance metric have not been obtained by the system. The zone 1350 includes a threshold value 1352 (e.g., 10 seconds) for progression to the next zone as indicated by the arrow 1354.

In the illustrative embodiment, the zone 1340 corresponds to a points score of between 1,250 and 2,500 points (see FIG. 14). The zone 1340 is located in closer proximity to the target zone 1330 than the zone 1350. The zone 1340 includes a threshold value 1342 (e.g., 12 seconds) for progression to the next zone as indicated by the arrow 1344.

It should be appreciated that in the illustrative embodiment, each of the displays 1300, 1400 presents a particular agent performance metric with zone labels, colors, value thresholds, and points in a user-friendly and readable manner. The gamification zones 1310, 1320, 1330, 1340, 1350 may be displayed with a direction icon (e.g., arrows) and distinct colors. In one example, the target zone 1330 may be colored gold when the maximum points for the particular performance metric are achieved. The point scores and score ranges may be visible upon selecting, or hovering a cursor over, the gamification zones 1310, 1320, 1330, 1340, 1350. A gem icon 1402 may be displayed to represent points. In some embodiments, when the maximum points are achieved, the gem icon 1402 may be accompanied by glowing marks (see FIG. 14). A particular user's value (e.g., raw performance indicator) may be displayed by a line through the appropriate zone (e.g., the lines 1338, 1438). An average raw performance indicator for a team in which the particular agent is included may be represented by a group icon (e.g., group icons 1304, 1404).

For the purposes of the present disclosure, it should be appreciated that the displays or visualized representations 300, 1400, 1500 are exemplary and that other displays or visualized representations may be displayed and/or generated by the system to support one or more configurations specific to a particular customer. In some embodiments, the system is capable of defining and/or supporting X number of gamification zones that each have different edges/limits and are each continuous. In one example, X is an any value from −66 to 7000, and the number of gamification zones are defined according to a particular customer configuration. In some embodiments, the system is capable of defining and/or supporting a “lower is better to minimum” objective associated with four gamification zones. Additionally, in some embodiments, the system is capable of defining and/or supporting a “lower is better” objective associated with four gamification zones. In other embodiments, the system is capable of defining and/or supporting a “higher is better to maximum” objective associated with four gamification zones. In other embodiments still, the system is capable of defining and/or supporting a “target area” objective associated with five gamification zones. Further, in other embodiments, the system is capable of defining and/or supporting a “lower is better” objective associated with three gamification zones.

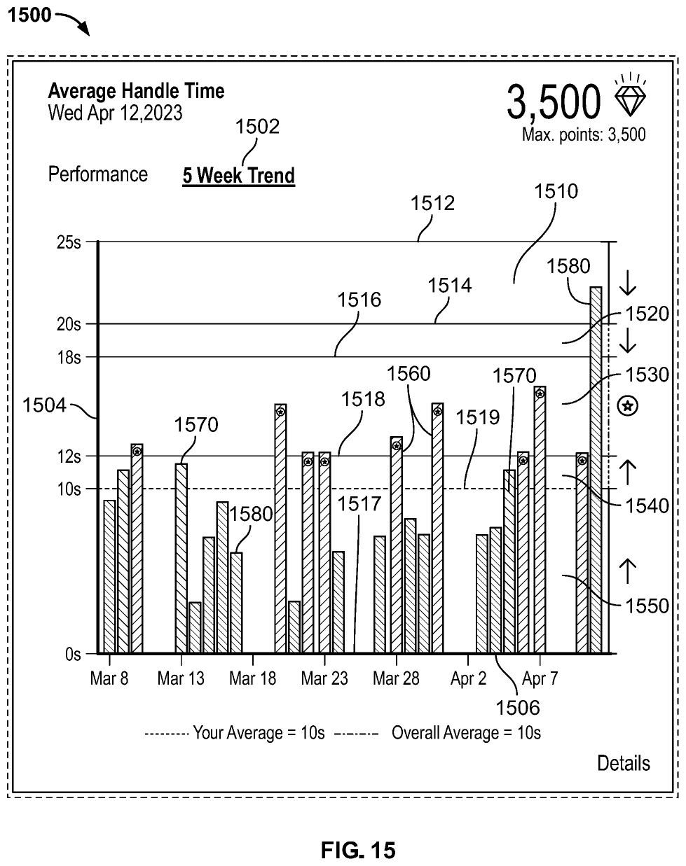

Referring now to FIG. 15, a display or visualized representation 1500 may be generated and displayed in response to selecting a trend tab 1502 presented in each of the displays 1300, 1400. In the illustrative embodiment, the display 1500 provides a graphical illustration of trend data for the particular performance metric (e.g., “Average Handle Time”) over a five-week timespan. The vertical axis 1504 represents the raw performance indicator (measured in seconds) and the horizontal axis 1506 represents time (days over the five-week timespan).

A region 1510 of the graph corresponds to the gamification zone 1310 and has an upper limit 1512 (e.g., 25 seconds) and a lower limit 1514 (e.g., 20 seconds). A region 1520 of the graph corresponds to the gamification zone 1520 and has an upper limit (e.g., the limit 1514) and a lower limit 1516 (e.g., 18 seconds). A region 1530 of the graph corresponds to the gamification zone 1330 and has an upper limit (e.g., the limit 1516) and a lower limit 1518 (e.g., 12 seconds). A region 1540 of the graph corresponds to the gamification zone 1340 and has an upper limit (e.g., the limit 1518) and a lower limit 1519 (e.g., 10 seconds). A region 1550 of the graph corresponds to the gamification zone 1350 and has an upper limit (e.g., the limit 1519) and a lower limit 1517 (e.g., zero seconds).

In the illustrative embodiment, performance indicator values that fall in the target zone 1330 are represented by bars 1560 each having a first color. Each of the bars 1560 illustratively extends to or into the region 1530. In some embodiments, the target zone 1330 and the bars 1560 may be shown in the first color to signify performance indicator values falling in the target zone 1330.

In the illustrative embodiment, performance indicator values that fall in either the zone 1320 or the zone 1340 are represented by bars 1570 each having a second color different from the first color. Each of the bars 1570 illustratively extends to or into the region 1540. In some embodiments, the zones 1320, 1340 and the bars 1570 may be shown in the second color to signify performance indicator values falling in one of the zones 1320, 1340.

In the illustrative embodiment, performance indicator values that fall in either the zone 1310 or the zone 1350 are represented by bars 1580 each having a third color different from the first color and the second color. Each of the bars 1580 illustratively extends to or into the region 1510 or the region 1550. In some embodiments, the zones 1310, 1350 and the bars 1580 may be shown in the third color to signify performance indicator values falling in one of the zones 1310, 1350.

Returning to FIG. 11, from block 1106, the illustrative method 1100 proceeds to block 1108. In block 1108, the system leverages game mechanics based on the resulting points scores to compare agents or employees and to encourage competition through leaderboards, contests, or head-to-head matchups. Such comparisons and competition may drive agents to strive for personal bests, rewards, or other incentives. The calculation of points scores may be used to drive agent engagement and foster intrinsic motivation such that agents perform tasks for personal satisfaction/reward rather than external benefits/rewards. Examples of intrinsic motivation may include, but are not limited to, achieving a personal best in points (on a daily, weekly, or monthly basis), reaching a desired level on a leaderboard based on points, progressing or improving points scores over a given time period, and receiving positive feedback (e.g., likes) from peers based on points.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A system for evaluating agent performance comprising:
at least one processor; and
at least one memory having a plurality of instructions stored therein that, in response to execution by the at least one processor, causes the system to:
obtain metric data for one or more agents including a plurality of raw performance indicators each corresponding to a particular agent performance metric of a plurality of agent performance metrics;
convert, based on the metric data, each of the plurality of raw performance indicators into a points score for the particular agent performance metric to provide a plurality of points scores for the plurality of agent performance metrics;
calculate, based on the points score, a goal percentage for each particular agent performance metric to provide a plurality of goal percentages for the plurality of agent performance metrics; and
compare, based on the plurality of goal percentages, agent performance over the plurality of agent performance metrics,
wherein to convert each of the plurality of raw performance indicators into a points score comprises to normalize the points score for the particular agent performance metric across a plurality of variables to evaluate agent performance according to a common standard.

2. The system of claim 1, wherein to normalize the points score for the particular agent performance metric comprises to establish a plurality of zones in progression toward a target for the conversion of at least one raw performance indicator corresponding to the particular agent performance metric into the points score.

3. The system of claim 2, wherein to normalize the points score for the particular agent performance metric comprises to determine the points score based on the particular zone of the plurality of zones that the at least one raw performance indicator falls in.

4. The system of claim 3, wherein to determine the points score based on the particular zone comprises to determine whether the at least one raw performance indicator falls in a first zone corresponding to a first points score, and wherein the first points score is zero points.

5. The system of claim 4, wherein to determine the points score based on the particular zone comprises to determine whether the at least one raw performance indicator falls in a second zone closer to the target than the first zone, and wherein the second zone corresponds to a second points score that is greater than the first points score.

6. The system of claim 5, wherein to determine the points score based on the particular zone comprises to determine whether the at least one raw performance indicator falls in a third zone closer to the target than the second zone, and wherein the third zone corresponds to a third points score that is greater than the second points score.

7. The system of claim 1, wherein to calculate the goal percentage for each particular agent performance metric comprises to multiply the points score for the particular agent performance metric by a predetermined number of days to compute an aggregated points score for the particular agent performance metric over a predefined time interval.

8. The system of claim 7, wherein to calculate the goal percentage for each particular agent performance metric further comprises to divide the aggregated points score by a maximum number of points achievable over the predefined time interval to determine the goal percentage.

9. The system of claim 1, wherein to compare agent performance over the plurality of agent performance metrics comprises to, for each agent in an agent profile selected by a user, display the plurality of goal percentages for a plurality of agent performance metrics assigned to the particular agent to facilitate visualized comparison of agent performance across the selected agent profile.

10. The system of claim 9, wherein to compare agent performance over the plurality of agent performance metrics comprises to calculate, for each agent in the selected agent profile, an overall goal percentage value corresponding to an average of the plurality of goal percentages for the plurality of performance metrics assigned to the particular agent.

11. The system of claim 10, wherein to display the plurality of goal percentages for the plurality of agent performance metrics comprises to display, for each agent in the selected agent profile, the overall goal percentage value to facilitate visualized comparison of overall goal percentage value across the selected agent profile.

12. A method of evaluating agent performance comprising:
obtaining metric data for one or more agents including a plurality of raw performance indicators each corresponding to a particular agent performance metric of a plurality of agent performance metrics;
converting, based on the metric data, each of the plurality of raw performance indicators into a points score for the particular agent performance metric to provide a plurality of points scores for the plurality of agent performance metrics;
calculating, based on the points score, a goal percentage for each particular agent performance metric to provide a plurality of goal percentages for the plurality of agent performance metrics; and
comparing, based on the plurality of goal percentages, agent performance over the plurality of agent performance metrics,
wherein converting each of the plurality of raw performance indicators into a points score comprises normalizing the points score for the particular agent performance metric across a plurality of variables to evaluate agent performance according to a common standard, and
wherein comparing agent performance over the plurality of agent performance metrics comprises comparing, for each agent in an agent profile selected by a user, agent performance for the particular agent over a first predefined time interval to agent performance for the particular agent over a second predefined time interval.

13. The method of claim 12, wherein normalizing the points score for the particular agent performance metric comprises:
establishing a plurality of zones in progression toward a target for the conversion of at least one raw performance indicator corresponding to the particular agent performance metric into the points score; and
determining the points score based on the particular zone of the plurality of zones that the at least one raw performance indicator falls in.

14. The method of claim 13, wherein determining the points score based on the particular zone comprises:
determining whether the at least one raw performance indicator falls in a first zone that corresponds to a first points score;
determining whether the at least one raw performance indicator falls in a second zone closer to the target than the first zone that corresponds to a second points score; and
determining whether the at least one raw performance indicator falls in a third zone closer to the target than the second zone that corresponds to a third points score.

15. The method of claim 14, wherein the first points score is zero points, the second points score is greater than the first points score, and the third points score is greater than the second points score.

16. The method of claim 12, wherein calculating the goal percentage for each particular agent performance metric comprises:
multiplying the points score for the particular agent performance metric by a predetermined number of days to compute an aggregated points score for the particular agent performance metric over a predefined time interval; and
dividing the aggregated points score by a maximum number of points achievable over the predefined time interval to determine the goal percentage.

17. The method of claim 12, wherein comparing agent performance over the plurality of agent performance metrics comprises:
displaying, for each agent in the selected agent profile, the plurality of goal percentages for a plurality of agent performance metrics assigned to the particular agent to facilitate visualized comparison of agent performance across the selected agent profile;
calculating, for each agent in the selected agent profile, an overall goal percentage value corresponding to an average of the plurality of goal percentages for the plurality of performance metrics assigned to the particular agent; and
displaying, for each agent in the selected agent profile, the overall goal percentage value to facilitate visualized comparison of overall goal percentage value across the selected agent profile.

18. The method of claim 12, wherein comparing agent performance over the first predefined time interval to agent performance over the second predefined time interval comprises displaying, for a particular agent in the selected agent profile over each of the first and second predefined time intervals, the goal percentage for the particular agent performance metric, the raw performance indicator corresponding to the particular agent performance metric, a number of days over which metric data including the raw performance indicator has been obtained, and the points score for the particular agent performance metric.

19. One or more non-transitory machine readable storage media comprising a plurality of instructions stored thereon that, in response to execution by a processor, causes the processor to:
obtain metric data for one or more agents including a plurality of raw performance indicators each corresponding to a particular agent performance metric of a plurality of agent performance metrics;
convert, based on the metric data, each of the plurality of raw performance indicators into a points score for the particular agent performance metric to provide a plurality of points scores for the plurality of agent performance metrics;
calculate, based on the points score, a goal percentage for each particular agent performance metric to provide a plurality of goal percentages for the plurality of agent performance metrics; and
compare, based on the plurality of goal percentages, agent performance over the plurality of agent performance metrics.

20. The one or more non-transitory machine readable storage media of claim 19, wherein to convert each of the plurality of raw performance indicators into a points score comprises to normalize the points score for the particular agent performance metric across a plurality of variables to evaluate agent performance according to a common standard.
